(19) United States
(12) Patent Application Publication
(10) Pub. No.: US 2006/0168960 A1
(43) Pub. Date: Aug. 3, 2006

(54) Machine and system for solar power generation

(76) Inventor: Wayne Krouse, Houston, TX (US)

Correspondence Address: JAMES D. PETRUZZI, 4900 WOODWAY SUITE 745, HOUSTON, TX, 77056, US

(21) Appl. No.: 11/050,388

(22) Filed: Feb. 3, 2005

(51) Int. Cl. B60K 16/00; F03G 6/00; B60L 8/00

(52) U.S. Cl. 60/641.8

(57) ABSTRACT

A solar collector for focusing radiant energy having a longitudinal member having translucent refraction and a lens that is positioned to receive electromagnetic radiation from the sun having a variable cross sectional dimension along its length positioned in proximity to a vessel of liquid; where the solar energy is focused on the liquid at a plurality of focal points of different length. The solar collectors may be used in a system for power generation where the lens has a variable cross sectional profile along its length disposed in proximity to a liquid for converting an inlet stream of liquid to an outlet flow of steam and a heat engine responsive to the liquid flow of steam for generating mechanical energy. The system may be used to power electrical turbines to store energy or supply the grid. The lenses may of a variety of cross sectional dimensions to focus the solar energy on various focal points within the liquid path.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### CROSS REFERENCE TO RELATED APPLICATIONS

Not Applicable

### FIELD OF INVENTION

This invention relates generally to the field of solar energy and more specifically to a machine and system for solar power generation.

### BACKGROUND OF THE INVENTION

It has been known for some time how to employ the sun's radiation to heat water and to utilize the heated water in a variety of ways to generate power. Existing solar energy systems circulate water through a system exposed to solar radiation to generate mechanical power from steam which in turn is used to drive various power systems such as electrical turbines. A limitation of prior art systems has been the efficiency at which they convert solar energy to other energy forms. Even in those instances where adequate extraction of solar energy is achieved, a lack of efficient energy transfer apparatus has precluded achieving the degree of efficiency that is required for commercial success.

U.S. Pat. No. 4,423,599 to Veale teaches a system in which solar energy is employed to boil a liquid to form a pressured gas the energy in which is converted to electrical energy in a special turbine and that uses a lens to focus the sun's energy onto a stream of water at a fixed focal point. This system fails to account for the reducing volume of the water as it is converted to steam and thereby focuses the energy of the sun at points where the maximum extraction of energy is not achievable. The present system overcomes these problems and others in a variety of new and useful ways.

### BRIEF SUMMARY OF THE INVENTION

It is an advantage of this invention to provide efficient and practical system elements, and a system employing them for the generation of electricity, using solar heating as the energy source.

Another advantage is to provide such a system in which solar energy is employed to convert water or other liquid to gas under pressure and then to expand that gas to operate a heat engine such as a gas or steam turbine.

A further advantage is to provide a solar collector for focusing the sun's energy in the most efficient manner for use in solar energy conversion system.

A further advantage is to provide an improved solar collector for use in converting a flow of water to a flow of steam by use of innovative lens configurations.

Yet another advantage of the present invention is to disclose a variety of lens configurations for the maximum extraction of solar energy.

Other objects and advantages of the present invention will become apparent from the following descriptions, taken in connection with the accompanying drawings, wherein, by way of illustration and example, embodiments of the present invention are disclosed.

In accordance with a preferred embodiment of the invention, there is disclosed a solar collector for focusing radiant energy having a longitudinal member having translucent refraction, a first top surface of the member that is positioned to receive electromagnetic radiation from the sun, a second bottom surface of the member formed by the member having a variable cross sectional dimension along its length positioned in proximity to a vessel of liquid, wherein the solar energy is focused on the liquid at a plurality of focal points of different length.

In accordance with a preferred embodiment of the invention, there is disclosed a machine for power generation through solar energy having a solar collector panel having at least one lens, the lens having a variable cross sectional profile along its longitudinal dimension, a liquid path disposed in proximity to the lens for converting an inlet stream of liquid to an outlet flow of steam or vapor, and a heat engine responsive to the liquid flow of steam or vapor for generating a mechanical energy output.

In accordance with a preferred embodiment of the invention, there is disclosed a system for power generation through solar energy having a longitudinal member having translucent refraction, a first top surface of the member that is positioned to receive electromagnetic radiation from the sun, a second bottom surface having a variable cross sectional dimension along the length of the member positioned above a body of contained liquid, wherein the solar energy is focused on a plurality of points on the opposite side of the second surface.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is schematic of electromagnetic radiation impacting on a solar concentrator tube.

FIG. 2 is a is a perspective view of a solar collector/concentrator tube.

FIG. 3A is a cross sectional view of a solar collector/concentrator tube in accordance with a preferred embodiment of the invention.

FIG. 3B is a cross sectional view of lens in accordance with a preferred embodiment of the invention.

FIG. 3C is a cross sectional view of lens in accordance with a preferred embodiment of the invention.

FIG. 3D is a cross sectional view of lens in accordance with a preferred embodiment of the invention.

FIG. 3E is a schematic and cross sectional view of a solar collector/concentrator and lens with ambient electromagnetic radiation in accordance with a preferred embodiment of the invention.

FIG. 3F is a cross sectional view of a base plate for placement of a plurality of solar collector/concentrator tubes in accordance with a preferred embodiment of the invention.

FIG. 4 is a schematic diagram of a power generation system in accordance with a preferred embodiment of the invention.

FIG. 5 is a block diagram of a steam turbine power generation system in accordance with a preferred embodiment of the invention.

FIG. 6A through 6H are alternate cross sectional views of different solar lenses in accordance with a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a representative basis for teaching one skilled in the art to employ the present invention in virtually any appropriately detailed system, structure or manner.

Turning now to FIG. 1, there is shown schematic diagram of a solar collector tube 12 placed in such a position as to obtain maximum solar radiation 14 with reflector 16 in position to further enhance the collection of solar energy. Collector tube 12 can be of a variety of configurations as more fully described below with the goal of focusing maximum energy on a material from which energy is extracted such as water or other low boiling point liquid.

A benefit of the inventive system disclosed herein is that a series of “solar concentrators”, or a solar collector in a single one pass or multiple pass tube or a bank of tubes in series or parallel enables maximum extraction of energy. The collector tube has a lens that focuses radiant energy to create heat in the liquid and/or vaporize a liquid in the tube that may or may not operate under a vacuum which in turn drives a turbine, drives a generator, etc. Prior art designs such as that shown in U.S. Pat. No. 4,423,599 are inefficient since the foci of the collection lens was at a constant height relative to the length of the tube.

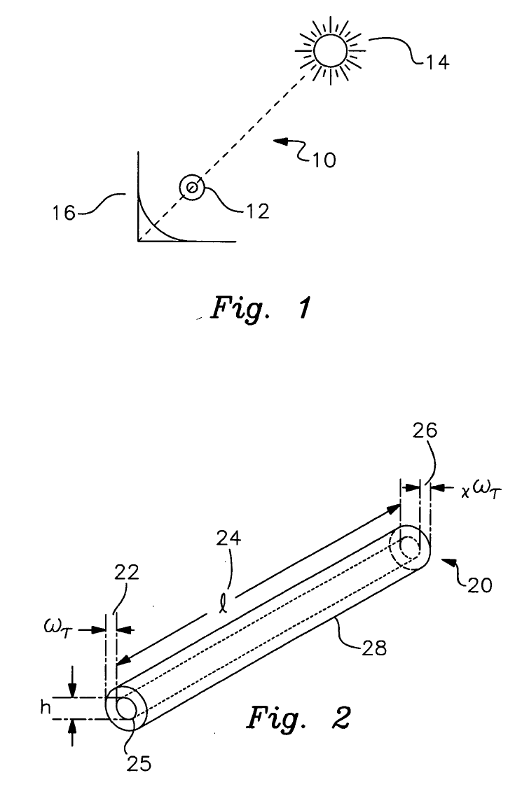

Turning now to FIG. 2, a tube 20 of length, l, 24 has an internal diameter, h, 25. At l=0, at one end of the tube 28, liquid composition is 100% and the low boiling point liquid height is h=h, and the vapor composition is 0%. At l=l, or the at the opposite end of tube 28, it is the opposite where all of the low boiling point liquid has been turned into vapor, the low boiling point liquid height is h=0, so liquid=0% and vapor=100%. As you move down the pipe from l=0 to l=l, the ratio of low boiling point liquid %/(liquid %+vapor %) decreases. As this ratio decreases, the height of the low boiling point liquid level decreases from h=h to h=0. In order for the solar collector to work optimally, which means the maximum vaporization of the low boiling point liquid and not instead, heating already formed vapor, its foci must be in the low boiling point liquid. Thus the present invention seeks to disclose a novel lens that changes shape (width and/or thickness) along the length of the tube so that the foci changes height from h=½ h (or some other point anywhere in the liquid volume at l=0) to the foci being at h=0 at l=l. Wall thickness W_{T} 22 may be varied so that at the opposite end of tube 20, wall thickness xW_{T} 26 is a fraction of wall thickness 22. As more fully described herein, the variation of the tube dimensions may be linear or non linear and alternatively may alter the inner dimension of the tube through which the water or low boiling point liquid flows. The inside of the tube 28 would preferably be coated with a commonly available material to insulate the system from both thermal and radiant energy loss.

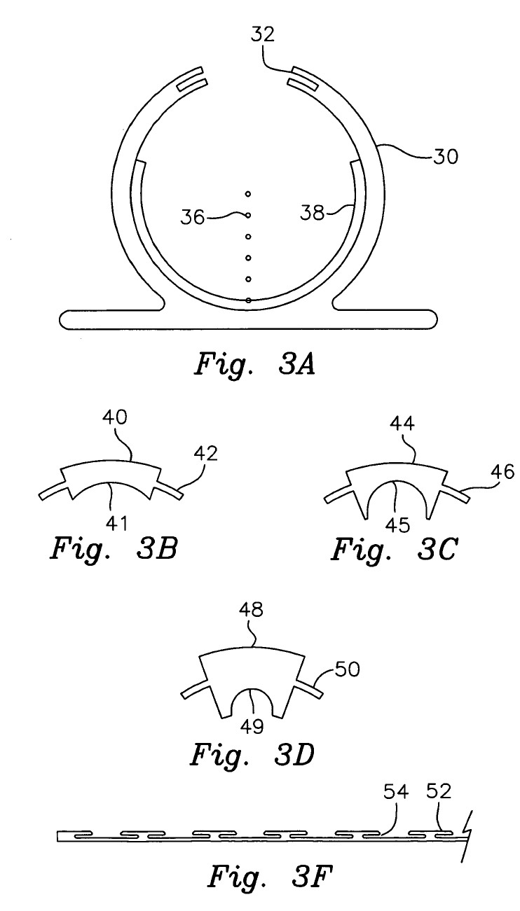

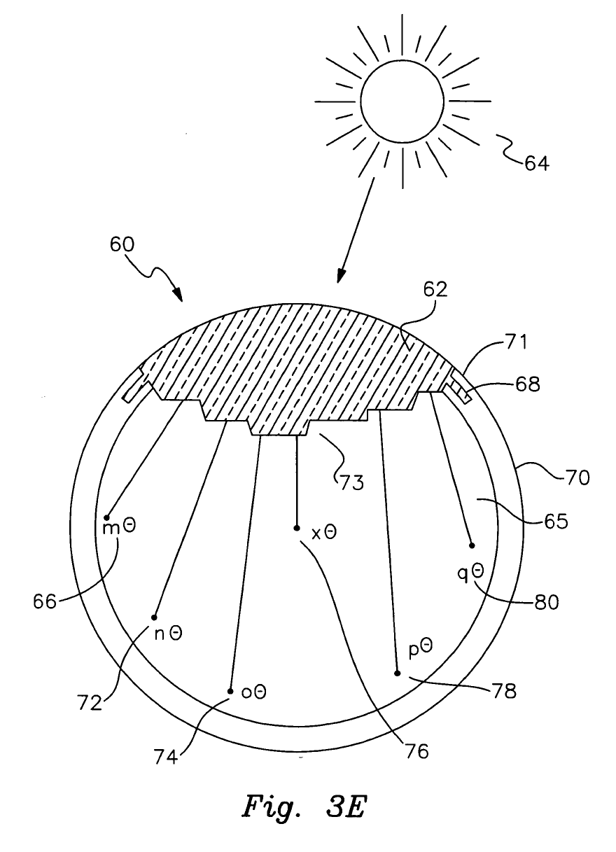

FIG. 3A shows a cross sectional view of one of a plurality of collector tubes 30 that may be used in the inventive system disclosed herein. Tube 30 has flanged legs 34 for insertion into a rack (further shown in FIG. 3F) for stable placement of the tube into a system of solar collectors. Tube 30 has slots 32 for insertion of a lens (not shown) that may be of any of a variety of dimensions or configurations. The lens that is chosen may have any of a number of focal points 36 along the length of the collector tube 30 to maximize liquid vaporization. Reflector surface 38 may be placed on the inside diameter of the tube 30 to further enhance energy absorption by liquid and act as an insulator.

FIG. 3B shows a cross sectional view of lens 40 having a generally concave inner surface 41 for focusing the radiation of the ambient sunlight as desired. Lens 40 has two tabs 42 on opposite sides of lens 40 for insertion into slot 32, for example, on a solar collector tube such as that shown in FIG. 3A. FIG. 3C shows a cross sectional view of lens 44 having an alternative concave inner surface 45 for focusing the radiation of the ambient sunlight as desired and tabs 46 for insertion into a solar collector tube. FIG. 3D shows a cross sectional view of lens 40 having an alternative concave inner surface 49 for focusing the radiation of the ambient sunlight as desired and tabs 50 for insertion into a solar collector tube.

FIG. 3E shows a cross sectional view of solar collector tube 60 placed in position to receive solar radiation 64 for heating of liquid passing through tube 60 in inner cavity 65. Tube 60 has a generally cylindrical body 70 with insertion slots 71 for reception of tabs 68 of a solar lens 62 in accordance with a preferred embodiment of the invention. Lens 62 has a multifaceted inner surface dimension 73 for focusing the solar radiation 64 in a plurality of foci points 66, 72, 74, 76, 78 and 80. Depending on the desired extraction characteristics desired, lens 62 may have a cross sectional dimension that is linear across the length of the lens or may vary across its length down the tube according to any of a variety of functions. It may be smoothly linear, logarithmic, step or other function to achieve the desired results.

FIG. 3F shows a base 52 for placement in a solar concentrator system having a plurality of slots 54 for insertion of solar collector tubes such as that shown in FIG. 3A by inserting legs 34 into slots 54. Base 52 may be employed on the roof of a building or other structure such as a free-standing stanchion to direct the sun's radiation to the solar collector tubes for maximum extraction of energy.

The solar collector can also be use in existing systems to heat water for pools or for home use. Thus the solar collector would be designed to heat water and not vaporize it. Since 50% of electric home energy use is used in electric water heaters to heat water in the United States, this novelty will provide significant cost savings and energy usage reductions. In a house, the solar collector would be put in line to heat water to a specific temperature. This can happen two ways by design with a once through system or by installing a circulation loop with a delta-T differential temperature controller which would stop circulation when the desired temperature set point was reached. This same design will also work for heating pool water.

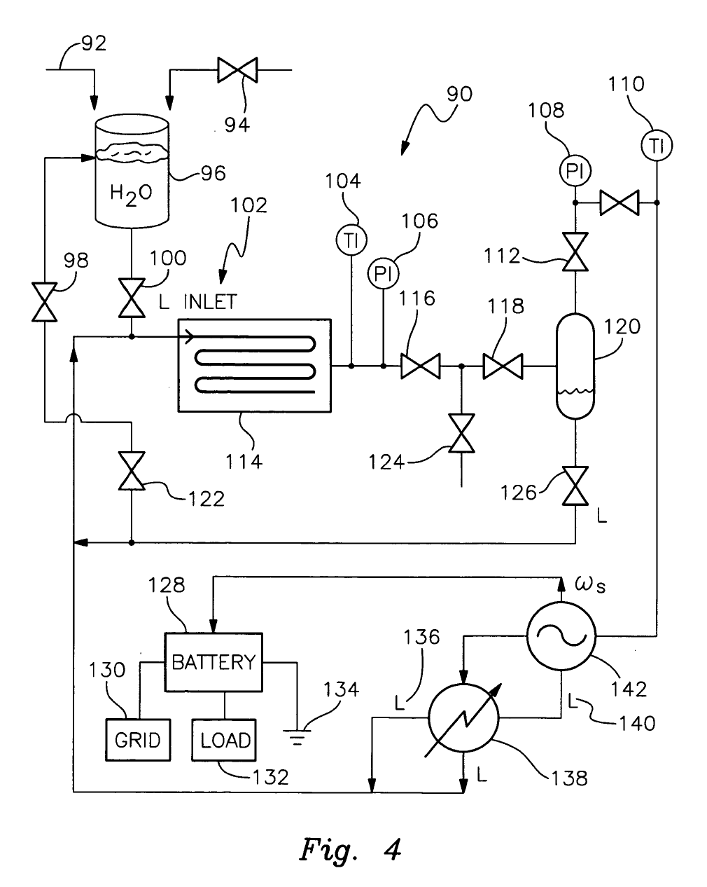

FIG. 4 shows a schematic diagram of a basic system utilizing the inventive aspects of the present invention. Water is introduced to a tank 96 through an inlet line 92 or through a valve 94 from a separate source. Water is introduced through valve 100 through inlet 102 to a solar concentrator 114. Solar concentrator 114 has a plurality of solar tubes aligned in such a way as to receive radiant energy and generate vapor. The collector/concentrator tubes can be under vacuum to lower the boiling point of the liquid and may contain any of a variety of liquids although water is preferably used. Temperature indicator gauge 104 and pressure indicator gauge 106 monitor system performance as desired. Pressurized vapor is delivered to a generator 142 which in turn generates electricity or stores power in a battery 128. Power from the battery may be delivered to the load 132, or excess may be transported to the grid 130. Any unvaporized water is separated in vapor liquid separator 120 and reintroduced into the system. A heat exchanger 138 used to help condense vapor after expansion in the turbine into liquid and reintroduction into the vaporization system.

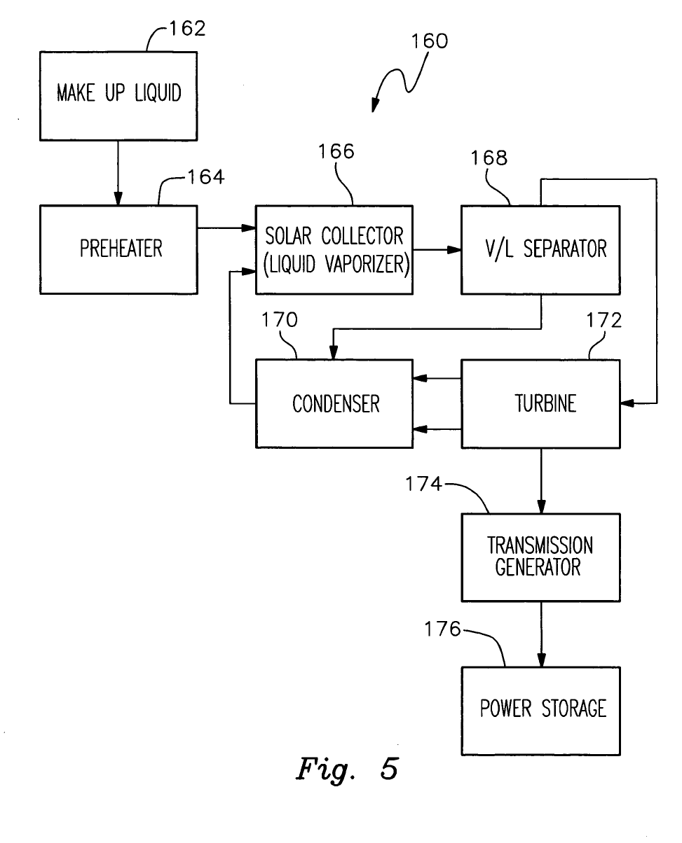

FIG. 5 shows a block diagram of a basic turbine system according the present invention. Make up liquid 162 is introduced to a pre-heater 164 before introduction to the solar collector 166. The make up liquid can be of any of a variety of liquids including low boiling point liquid, water or synthetic depending on the nature of the turbine, although conventionally it would be water. The liquid is vaporized in the collector 166 using solar collector tubes in accordance with the present invention. The solar collector tubes may be placed in certain embodiments on the roof of the structure housing the system in a series of holder trays for reception of maximum energy from the sun. In an alternative embodiment, the solar collector tubes may be mounted on a stanchion that moves with the sun to maintain the maximum exposure to the solar radiation.

As the liquid-vapor mixture is obtained, it is introduced into the vapor-liquid separator 168 which in turn sends the vapor to the turbine 172 and the left over liquid to the condenser 170. Spent vapor from the turbine 172 is also sent to the condenser for condensing and for reintroduction into the solar collector unit 166. The turbine 172 powers a transmission generator 174 which in turn delivers electricity for storage into power storage unit 176.

Another benefit of the present invention is that, by design, the concentrating lens may be part of the solar collector tube in which the water (or low blow boiling point liquid) flows. This is significant in that this design allows for ultra low cost manufacturing, assembly, maintenance and replacement. The components would be manufactured from all plastics or a plastic tube with glass lens at costs far below that of existing technologies. These devices can be mounted on the ground, on a roof top or anywhere that would get optimal radiant energy from the sun. This configuration is easily determined using existing commercial radiant energy measurement devices.

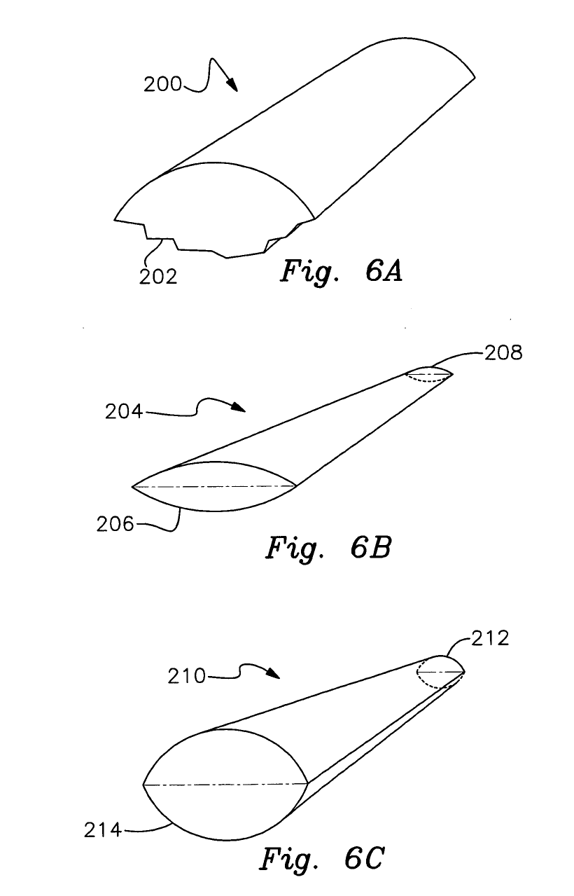

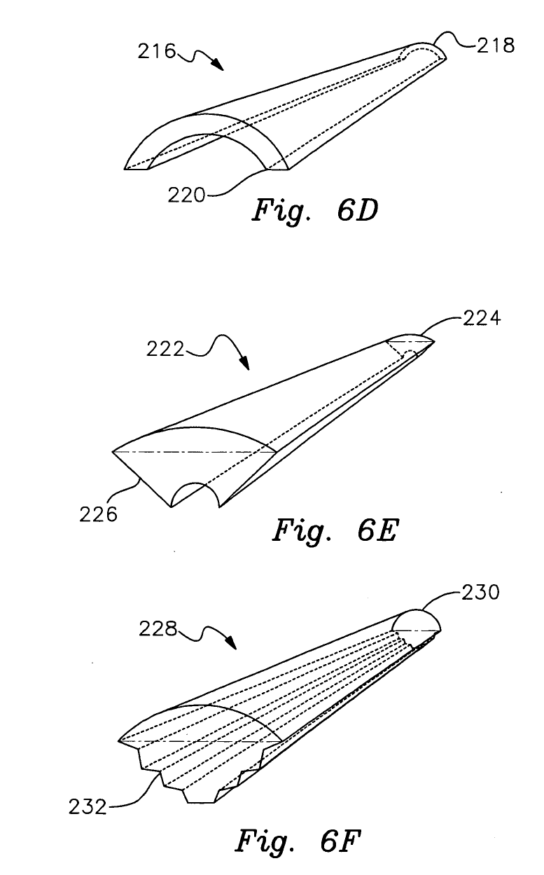

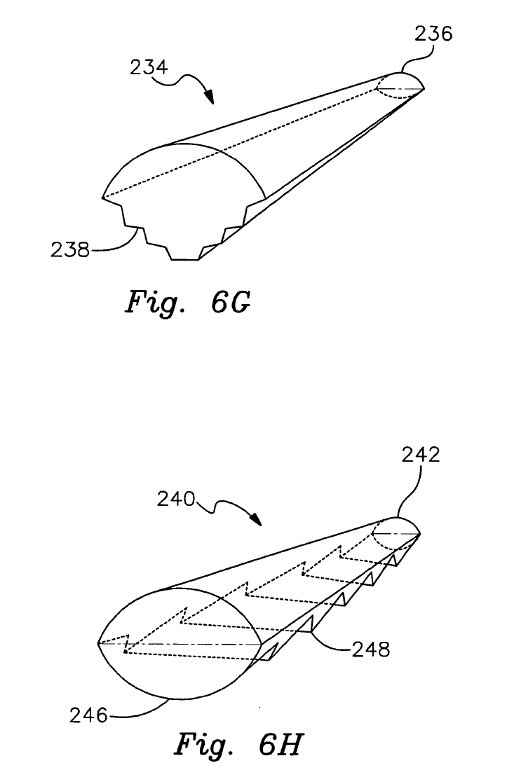

FIG. 6A through 6H show a variety of lens collector configurations. FIG. 6A shows lens 200 having a multi-dimensioned bottom surface 202 to refract light to different focal points. FIG. 6B shows lens 204 having a smoothly varying convexity across the longitudinal dimension of the lens member from end 206 to end 208. The cross section defining the lens at end 206 is composed of different arcs than the arcs defining the cross section at end 208. FIG. 6C shows another lens 210 having a smoothly varying convexity where the end 212 has a smaller cross sectional dimension than opposite end 214. This type of configuration focuses the radiant energy at a descending focal point length from the center of the lens to facilitate heating the maximum amount of liquid by having the energy in the liquid below and not focusing on the vapor portion of the liquid flow. FIG. 6D shows lens 216 having a concave bottom surface 217 and a cross dimensional variation of the thickness of the lens from end 218 to opposite end 220. FIG. 6E shows lens 222 with a variation of a concave lens configuration on the bottom surface and a varying thickness of the lens across the length of the lens from end 224 to end 226. FIG. 6F shows multifaceted lens 228 having a varying cross sectional surface area at end 230 from end 232. FIG. 6G shows lens 234 with a step function style cross section that focuses light energy at several pre-determined focal points. The cross section of lens 234 may be of varying cross sectional surface area in a smooth function across its length or have some other varying function. It may also be non-varying across its length depending on the application. FIG. 6H shows lens 240 with saw tooth pattern 248 and a varying cross sectional surface area from end 242 to end 246. All of the above lens configurations permit a fine tuning of the light refraction and focusing of energy in the stream of water or other liquid to best maximize the extraction of energy. Depending on the particular liquid, solar radiation and other factors, these configurations or a combination thereof might be employed on different lenses in the same system to achieve the maximum benefits. By having a lens configuration that changes across the length of the solar tube, as the water or other liquid is heated and converted to vapor or steam as the case may be, the focus of the sun's energy is more appropriately directed to the portion of the water or liquid that one would like to heat rather than the vapor.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

1. A solar collector for focusing radiant energy comprising:
a longitudinal member having translucent refraction;
a first top surface of said member that is positioned to receive electromagnetic radiation from the sun;
a second bottom surface of said member formed by said member having a variable cross sectional dimension along its length positioned in proximity to a vessel of liquid;
wherein said solar energy is focused on said liquid at a plurality of focal points of different length.

2. A solar collector as claimed in claim 1 further wherein said cross section increases or decreases over the length of the member.

3. A solar collector as claimed in claim 1 wherein said cross sections approximate a saw tooth pattern

4. A solar collector as claimed in claim 1 wherein said bottom surface is multifaceted.

5. A solar collector as claimed in claim 1 wherein said bottom surface is described by varying arcs along its length.

6. A machine for power generation through solar energy comprising:
a solar collector panel having at least one lens;
said lens having a variable cross sectional profile along its longitudinal dimension;
a liquid path disposed in proximity to said lens for converting an inlet stream of liquid to an outlet flow of steam or vapor; and
a heat engine responsive to said liquid flow of steam or vapor for generating a mechanical energy output.

7. A machine for power generation through solar energy as claimed in claim 6 wherein said mechanical output drives an electrical generator.

8. A machine for power generation through solar energy as claimed in claim 6 wherein said lens has a plurality of varying cross sections that each generate a focal point of energy in each plane of said cross section.

9. A machine for power generation through solar energy as claimed in claim 6 further comprising wherein said lens focuses radiant energy within the body of said liquid.

10. A machine for power generation through solar energy as claimed in claim 8 wherein said focal points form a linear path across said liquid.

11. A machine for power generation through solar energy as claimed in claim 10 having a plurality of focal points for each cross section along the length of the lens.

12. A system for power generation through solar energy comprising:
a longitudinal member having translucent refraction;
a first top surface of said member that is positioned to receive electromagnetic radiation from the sun;
a second bottom surface having a variable cross sectional dimension along the length of the member positioned above a body of contained liquid;
wherein said solar energy is focused on a plurality of points on the opposite side of said second surface.

13. A system for power generation through the solar energy as claimed in claim 12 wherein said liquid generates steam to create mechanical energy.

14. A system for power generation through the solar energy as claimed in claim 13 wherein said mechanical energy is converted to electrical power.
